(19) United States
(12) Patent Application Publication
(10) Pub. No.: US 2016/0110044 A1
(43) Pub. Date: Apr. 21, 2016

(54) PROFILE-DRIVEN AVATAR SESSIONS

(71) Applicant: Microsoft Corporation, Redmond, WA (US)

(72) Inventors: Anton Oguzhan Alford Andrews, Seattle, WA (US); Kenneth Marks, Redmond, WA (US); Frederick David Jones, Bellevue, WA (US)

(21) Appl. No.: 14/518,477

(22) Filed: Oct. 20, 2014

(51) Int. Cl. G06F 3/0484; G06F 9/44; G06F 3/01

(52) U.S. Cl. CPC G06F 3/0484; G06F 3/013; G06F 9/4446

(57) ABSTRACT

Disclosed herein are systems, methods, and software to enhance avatar technology. An avatar engine identifies a session profile to apply to an avatar session when evaluating user actions generated by a user for potential expression in avatar actions associated with an avatar. The engine evaluates the user actions to determine if the user actions agree with the session profile for the avatar session. When the user actions do agree, they may be expressed through the avatar. For at least a user action that does not agree with the session profile for the avatar session, the avatar is driven to express a modified version of the user action that does agree with the session profile.

### TECHNICAL BACKGROUND

Avatar technology allows users to interact with others remotely through avatars that are capable of expressing representations of their gestures, movements, speech, and other actions. In a typical scenario, the actions of a user are captured and input to an avatar engine for analysis. The avatar engine drives a corresponding avatar to output actions that correspond to the user's actions. So when the user waves and says “hello”, for example, her avatar also waves and says “hello.”

One drawback to interacting with avatars is that they lack empathy and most avatar sessions fall short of a real experience with another person as a result. A great deal of development has gone into improving the realism of avatar sessions and the empathy sensed by those participating in avatar session. For instance, avatar graphs are increasingly realistic, including their facial expressions, movements, and the like. The more realistic avatars become, the more empathy and connectedness they foster with session participants.

### OVERVIEW

Provided herein are systems, methods, and software to enhance avatar technology. In various implementations, user actions are translated to avatar actions using session profiles that can differ on a per-session basis. The session profiles function to map user functions to avatar functions in a way that is appropriate under the circumstances for a given session, which may contribute to perceptions of empathy and connectedness.

In at least one implementation, an avatar engine identifies a session profile to apply to an avatar session when evaluating user actions generated by a user for potential expression in avatar actions associated with an avatar. The engine evaluates the user actions to determine if the user actions agree with the session profile for the avatar session. When the user actions do agree, they may be expressed through the avatar. For at least a user action that does not agree with the session profile for the avatar session, the avatar is driven to express a modified version of the user action that does agree with the session profile.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates an operational scenario involving enhanced avatar technology in an implementation.

FIG. 2 illustrates another operational scenario involving enhanced avatar technology in an implementation.

FIG. 3 illustrates a translation process in an implementation.

FIGS. 4A-4C illustrate translation examples in various implementations.

FIG. 5 illustrates a translation table in an implementation.

FIG. 6 illustrates an example session flow in an implementation.

FIG. 7 illustrates an example avatar architecture and session.

FIG. 8 illustrates a computing system representative of any system or systems suitable for implementing any of the architectures, applications, services, processes, and operational scenarios and sequences disclosed herein with respect to FIGS. 1-7 and discussed in the Technical Disclosure below.

### TECHNICAL DISCLOSURE

Implementations disclosed herein enable enhanced avatar technology. The enhanced avatar technology allow user actions to be translated to avatar actions in a session-specific manner, so that the customs and expectations for a particular session can be met. By tailoring translations on a per-session basis, the empathy and connectedness perceived by those interacting with an avatar may be increased, which can improve the overall usability of avatar technology and reduce resistance to adopting such technology.

In at least one implementation, an avatar engine identifies a session profile to apply to an avatar session when evaluating user actions generated by a user for potential expression in avatar actions associated with an avatar. The engine evaluates the user actions to determine if the user actions agree with the session profile for the avatar session. When the user actions do agree, they may be expressed through the avatar. For a user action that does not agree with the session profile for the avatar session, the avatar is driven to express a modified version of the user action that does agree with the session profile.

A session profile may be selected from a variety of possible profiles based on a context of the avatar session, which itself can be determined from the characteristics of a session. Examples of session characteristics include, but are not limited to, the identity of those participating on a given session, the nature of a relationship between participants, a quantity of participants engaged in a session, and a level of familiarity between the participants.

Some or all of the aforementioned may be determined automatically. For instance, an avatar engine could analyze the identity of session participants to determine the nature of the relationship between them. Having ascertained the context from session characteristics, the engine can select an appropriate profile for the session.

In a brief example, a user may establish an avatar session with another user. An avatar engine may ascertain that the two users are co-workers and communicate very frequently. As such, the engine may conclude that the context of the session is work-based, but casual. Such a context will correspond to a particular session profile. The session profile can then be applied when translating user actions to avatar actions.

In another example, a user may establish an avatar session with another user who work in upper management for a customer. An avatar engine may conclude that the context is very formal when considering the relative roles and positions of the two participants. A corresponding session profile can be selected based on this determination and applied when driving the user's avatar.

In other cases, tools may be provided that allow one or more of the participants to select the profile for a session. For example, a user could select a specific profile from a list of profiles in a menu. The selection could be made when initiating a session (e.g. placing a call), during the session, or even earlier when scheduling an avatar session.

The variety of possible profiles each comprise a different range of allowed actions. Thus, one session profile may allow one range of actions, while another allows a different range of actions. The ranges may be entirely separate from one another or may overlap. An avatar engine evaluates user actions to determine if the user actions agree with a session profile by examining whether or not the user actions fall within the range of allowed actions. Those that do fall within an allowed range are considered to be in agreement with the session profile, while those that do not are considered to not be in agreement.

When an action is not in agreement with a session profile, a modified version of the user action may be generated and expressed through an avatar. In some cases, the modified action is a synthetic action that takes the place of the action. A synthetic action may be considered synthetic when it represents a distinct departure from the user action. For instance, refraining from expressing a user action via an avatar action would be a distinct departure and thus could be considered a synthetic action. In another example, a wave of the hand to greet someone other similar greeting may be translated into a bow or other type of formal greeting that is a distinct departure from the wave.

In other cases, the modified version of the action is a blend of only a portion of the user action and a synthetic action. In an example, a user may point towards the image of another user in a screen display with their index finger extended. The pointing gesture may be translated into an open-handed directional gesture. Thus, a portion of the user action is retained, but it is blended with a synthetic gesture. In yet other examples, a user may gesture in one direction, but the gesture is translated into a redirected gesture in the opposite direction, or an extended gaze may be translated into or supplemented with a redirected gaze.

In one implementation, a session profile is used to evaluate user actions that occur within interaction sequences during an avatar session. User actions generated by a user are captured by an avatar engine during an interaction sequence between an avatar and another participant in the avatar session. The avatar engine generates avatar actions for the interaction sequence that include a blend of synthetic avatar actions and user-driven avatar actions. The user-driven avatar actions may correspond to a subset of the user actions such that the avatar actions during the interaction sequence are in agreement with the session profile for the avatar session. The avatar engine drives the avatar to surface the avatar actions, including the blend of the synthetic avatar actions and the user-driven actions.

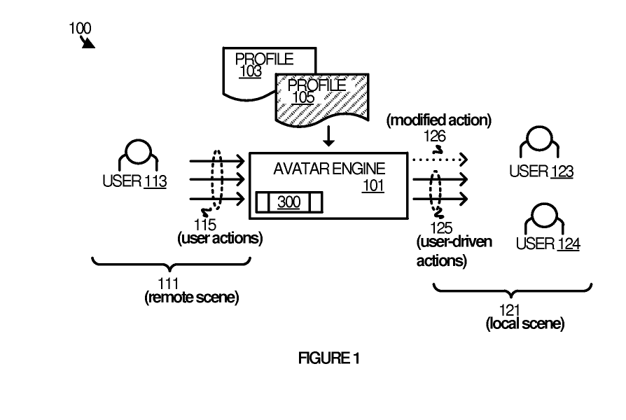

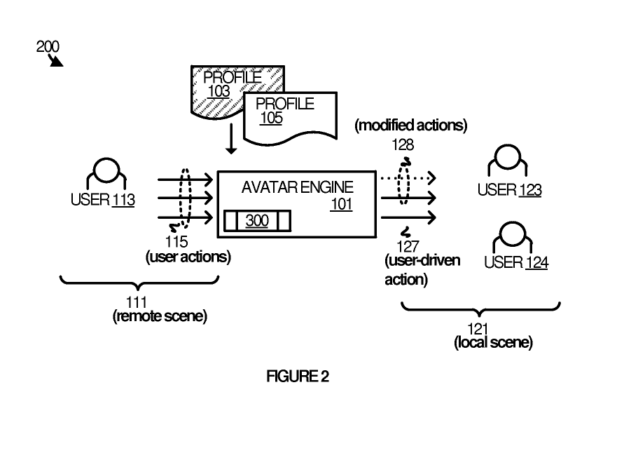

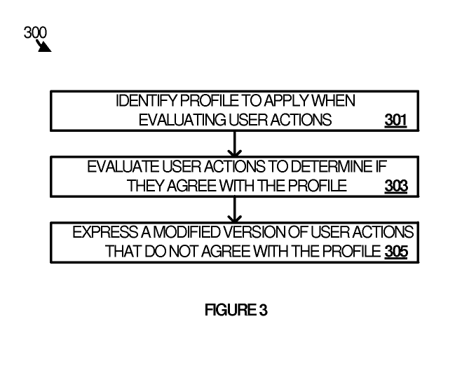

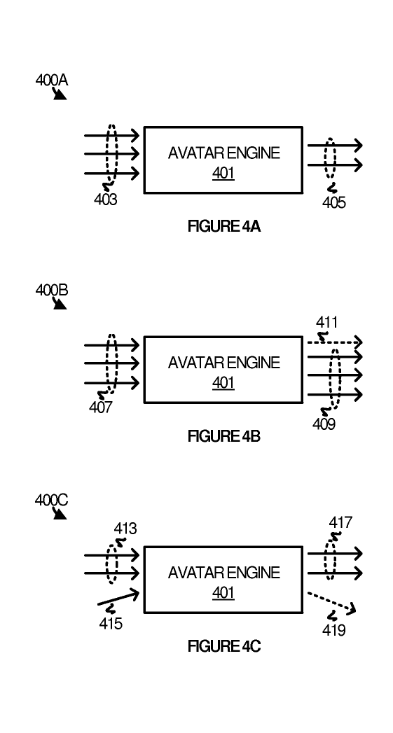

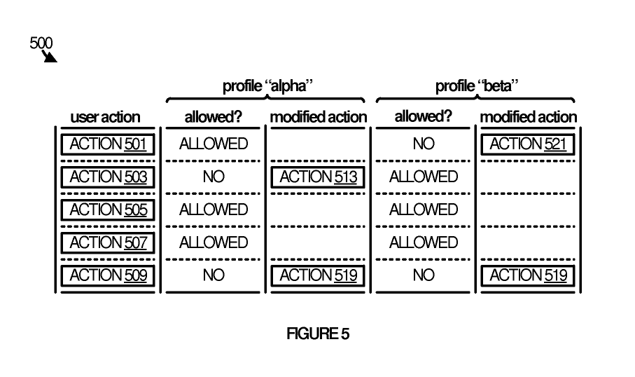

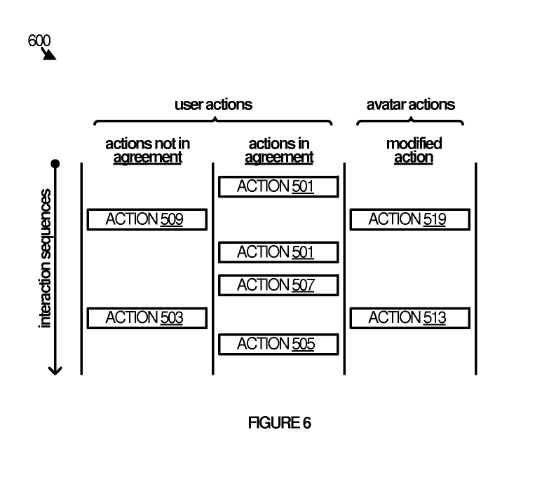

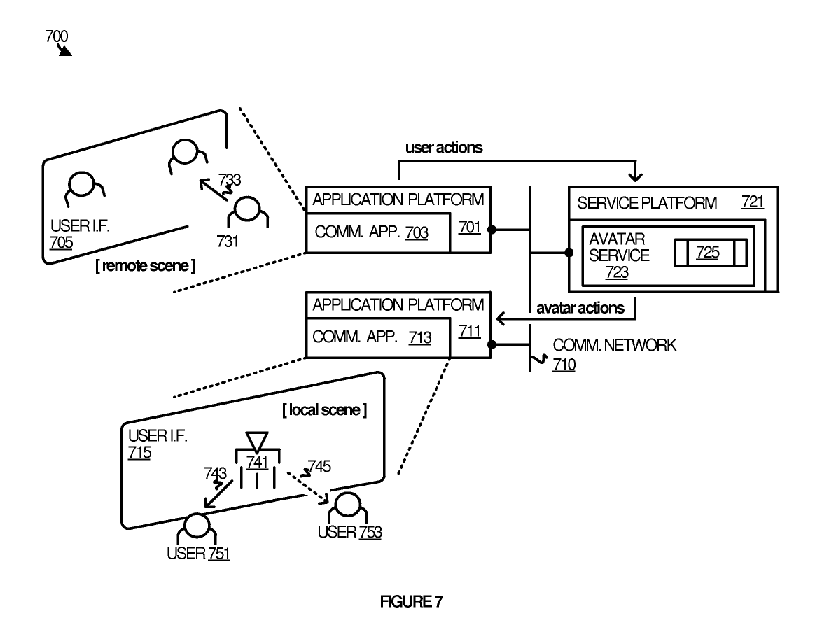

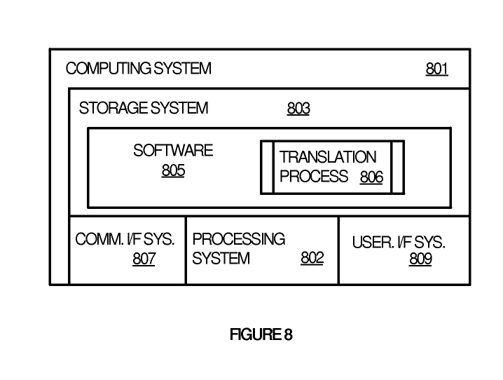

Turning now to the drawings, FIG. 1 illustrates an operational scenario involving enhanced avatar technology in which a session profile is applied when translating between user actions and avatar actions. FIG. 2 illustrates another scenario in which a different session profile is utilized, to highlight the different results obtained when different profiles are applied. FIG. 3 illustrates a translation process that may be employed by avatar engines while FIGS. 4A-4C illustrate various translation examples. FIG. 5 illustrates a translation table and FIG. 6 illustrates an example session flow using the table. FIG. 7 illustrates an example avatar architecture and session. FIG. 8 illustrates a computing system suitable for implementing enhanced avatar technology as disclosed herein.

Referring to FIG. 1, operational scenario 100 involves an avatar engine 101 that translates user actions to avatar actions. In operation, avatar engine 101 loads one of session profile 103 and session profile 105 with which to evaluate user actions generated in remote scene 111. User 113 is positioned in remote scene 111 and generates user actions 115. The user actions 115 are captured and processed by avatar engine 101 to render avatar actions in local scene 121. The avatar actions are surfaced and presented to user 123 and user 124 in the context of an avatar session. In this example, the avatar actions include user-driven actions 125 and a modified action 126.

FIG. 2 illustrates operational scenario 200 to demonstrate how different session profiles may produce different translations relative to each other. Operational scenario 200 involves the same elements as operational scenario 100. However, in operational scenario 200, it is assumed for exemplary purposes that avatar engine 101 has selected session profile 103 to apply to user actions 115.

In particular, avatar engine 101 outputs user driven action 127 and modified actions 128, which differ relative to the avatar actions output in operational scenario 100. This may be the case when, for example, one session profile allows certain user actions, while another session profile does not. The same user actions will be processed differently and different avatar actions may result.

Avatar engine 101 employs translation process 300 when translating user actions 115 into avatar actions, a more detailed illustration of which is provided in FIG. 3. The following description of translation process 300 makes parenthetical reference to the steps illustrated in FIG. 3, although it may be appreciated that translation process 300 may include additional functionality. Translation process 300 is representative of any application software program, program module, component, or collection thereof through which the steps illustrated in FIG. 3 may be implemented.

In operation, translation process 300 identifies a profile to apply when evaluating user actions during an avatar session (step 301). This may be accomplished by checking user settings that specify which profile to use. In other examples, user settings may specify a context for the session, such as a formal context, an informal context, an internal context, a managerial context, a sales context, and so on.

The context can also be determined automatically by examining various characteristics of the session, including the identities of the participants, how the participants are related to each other, how familiar the participants are with each other, and how many participants there are.

Avatar engine 101 may accomplish any of the aforementioned examples by accessing and processing session-related information. The information may be obtained by querying session clients, accessing a service data based, reading a configuration file, examining a graph, or by any other suitable mechanism.

Next, avatar engine 101 evaluates user actions to determine if they agree or disagree with the session profile (step 303). In operational scenarios 100 and 200, user 113 generates user actions 115, which are representative of gestures, movements, speech, eye movement, and other types of user actions. Even the absence of an action may sometimes be considered a user action. User actions 115 may be generated by user 113 in parallel relative to each other, in series, or in some combination or variation thereof.

User actions 115 are captured by a capture device or devices, such as a camera, microphone, and other sensors. Data resulting from the capture process may be processed by avatar engine 101 or some other element to identify the actions, which may then be evaluated in view of a session profile.

For those user actions that agree with the session profile, avatar engine 101 drives an avatar to express avatar actions that generally express the same actions as the user actions. For those user actions that do not agree with the session profile, avatar engine 101 drives the avatar to express modified versions of the user actions (step 305).

With respect to operational scenario 100 in FIG. 1, avatar engine 101 selects session profile 105 to apply to user actions 115 during the session. The resulting avatar actions include user-driven actions 125 and modified action 126. The user-driven actions 125 may correspond to and generally represent a subset of user actions 115 that agree with session profile 105. Modified action 126 is representative of a synthetic action or a blend of a synthetic and non-modified action.

With respect to operational scenario 200 in FIG. 2, avatar engine 101 selects session profile 103 to apply to user actions 115 during the session. The resulting avatar actions include user-driven action 127 and modified actions 128. User-driven action 127 may correspond to and generally represents a user action 115 that agrees with session profile 103. Modified actions 128 are representative of synthetic actions or a blend of a synthetic and non-modified actions.

FIG. 4 illustrates several translation examples to further demonstrate various enhancements to avatar technology. In example 400A, avatar engine 401 receives user actions 403. Employing a translation process, of which translation process 400 is representative, avatar engine 401 produces user-driven actions 405. User-driven actions 405 include only two actions, whereas user actions 403 include three actions. Example 400A thus illustrates how avatar engine 401 may filter or eliminate a user action entirely when translating user actions to avatar actions. This may happen when a user, for example, is engaged in an avatar session as engages in a gesture, movement, or other action that is not in agreement with a profile for the session. Eating food, reaching down low for an object, and coughing are just some examples of user actions that might be filtered.

In example 400B, avatar engine 401 receives user actions 407 and produces user-driven actions 409 and synthetic action 411. This example illustrates how avatar engine 401 may produce a number of avatar actions that exceeds the number of user actions that seeded the translation process. Example 400B also illustrates how synthetic actions may be introduced to a set of avatar actions. This may occur when a user, for instance, neglects to include a greeting or a farewell gesture in a conversation. Avatar engine 401 may recognize the omission as a user action and can insert a proper greeting or farewell in the avatar actions.

Example 400C includes a representation of a redirected user actions, such as a redirected gaze or a redirected gesture. Avatar engine 401 receives user actions, which include user actions 413 and user action 415. User action 415 is representative of a directional action, such as gazing in one direction or pointing in one direction. Avatar engine 401 translates user actions 413 into user driven actions 417, while user action 415 is translated into avatar action 419, which may be a blend of a synthetic action and a user-driven action. For instance, a prolonged gaze may be translated into a redirection of the gaze for a brief moment, and then a return to the original direction of the gaze. In another example, a gesture in one direction towards an object or person may be redirected towards another object, person, or space.

FIG. 5 illustrates a translation table 500 that may be employed by an avatar engine when translating user actions to avatar actions. Translation table 500 includes various rows and columns. The first column identifies a list of user actions that may be generated by a user and captured by a suitable computing system. The user actions are represented by action 501, action 503, action 505, action 507, and action 509.

The second and third columns identify for a specific session profile (“alpha”) whether or not a given user action is allowed or in agreement with the session profile. The third and fourth columns identify whether or not a given user action is allowed for another session profile (“beta”).

In an operative example, an avatar engine queries translation table 500 to determine whether or not a particular user action is in agreement with a particular session profile. Table 500 may be queried using the identity of the user action and the identity of the session profile governing the associated avatar session. Thus, querying table 500 under session profile alpha and action 501 would reveal that action 501 is allowed. Table 500 would also reveal that action 505 and action 507 are in agreement with session profile alpha.

However, table 500 indicates that action 503 is not allowed. Rather, a modified action represented by action 513 is identified as the appropriate action to substitute for action 503. Table 500 also indicates that action 509 is not in agreement with session profile alpha and is to be replaced with action 519.

With respect to the second session profile, beta, table 500 indicates that action 501 is not allowed and is to be modified with action 521, while action 503, action 505, and action 507 are identified as allowed under the session profile. Action 509 is identified as not allowed under session profile beta. Table 500 identifies action 519 as the action with which to modify action 509 under session profile beta, just as with session profile alpha. It may thus be appreciated that two different profiles may vary in which user actions are allowed and not allowed. The profiles may also differ in their modifications, although overlap may exist between which actions are allowed and in how actions are modified.

Using this information, the avatar engine would either render an avatar action generally equal to an allowed user action or would render a modified action as specific in table 500. Other mechanisms for driving translations other than a table are possible, such as a linked list, a graph, or any other suitable technique.

FIG. 6 illustrates a session flow 600 in an example that demonstrates how table 500 in FIG. 5 may be employed. In this example flow, action 501 is received by an avatar engine. For exemplary purposes, it is assumed that the session profile “alpha” has been selected for this session. Accordingly, table 500 (or some other suitable mechanism for storing profile information) is queried based on action 501. Table 500 returns that the action is allowed and the avatar engine surfaces action 501 accordingly (via a corresponding user-driven avatar action).

Next, action 509 is received. Table 500 returns action 519 as action 509 is not allowed under the alpha session profile and is surfaced accordingly. Action 501 and action 507 are received after action 509. Both actions are allowed per the alpha session profile and are surfaced through an avatar accordingly. Action 503 is also received, which is a prohibited action per the alpha session profile. Action 503 is replaced with action 513, which is then surfaced via the avatar. Lastly, action 505 is received and surfaced as it is in agreement with the profile.

FIG. 7 illustrates a computing architecture 700 suitable for implementing enhanced avatar technology as disclosed herein. Computing architecture 700 includes application platform 701, application platform 711, and service platform 721. Application platform 701 hosts communication application 703, while application platform 711 hosts communication application 713. Communication applications 703 and 713 communicate with each other via avatar service 723 over communication network 710. Avatar service 723 is hosted on service platform 721.

In operation, communication application 703 renders a user interface 705 to avatar service 723 via which user 731 may engage in avatar sessions. Communication application 713 renders user interface 713 to avatar service 723 via which another user or users, represented by user 751 and user 753, may participate in avatar sessions. FIG. 7 illustrates one such avatar session: images of users 751 and 753 are displayed in user interface 705 to user 731. The images may or may not be part of an avatar. However, an avatar 741 corresponding to user 731 is rendered in user interface 715.

As user 731 talks, motions, gestures, moves about, or otherwise produces user actions in a remote scene, the user actions are captured by application platform 701 and its devices and processed by communication application 703. Communication application 703 communicates the user actions (or some indication or representation thereof) to service platform 721 and avatar service 723. Avatar service 723 employs a translation process 725 to translate the user actions into avatar actions. The avatar actions (or some indication or representation thereof) are communicated to application platform 711 and communication application 713. Communication application 713 renders the avatar actions in user interface 715 by driving avatar 741 to express the actions in the local scene.

For example, user 731 may make a gesture 733, which is captured and communicated to avatar service 723. Avatar service 723 translates the gesture to an avatar action per translation process 725. The avatar action is communicated to communication application 713 for rendering in user interface 715. In this scenario, gesture 733 is translated into a user-driven action 743 and a synthetic action 745.

Application platforms 701 and 711 are each representative of any physical or virtual computing system, device, or collection thereof capable of hosting an application, such as communication applications 703 and 713 respectively. Service platform 721 is representative of any physical or virtual computing system, device, or collection thereof capable of hosting an application service, such as avatar service 723. Computing system 801 in FIG. 8 is representative of any computing system suitable for implementing the aforementioned application platforms and service platforms.

Communication applications 703 and 713 are each representative of any client application capable of interacting with avatar service 723 and rendering user interfaces 705 and 715 respectively. Examples include, but are not limited to, unified communication applications, communication conferencing applications, instant messaging applications, chat applications, multi-media applications, virtual reality applications, web browsers, social networking applications, productivity applications, e-commerce applications, dedicated avatar applications, and gaming applications, as well as any other suitable application.

Communication applications 703 and 713 may each be a locally installed and executed application, executed in the context of a browser, hosted online, streamed, or delivered in any other suitable manner. Each application may be a mobile application, a desktop application, a hybrid application, or any other type, and may be configured for desktops, laptops, tablets, mobile devices, wearable devices, or any other form factor suitable for surfacing an indication of meeting effectiveness.

Avatar service 723 is representative of any service capable of interacting with communication applications 703 and 713. Examples of avatar service 723 include, but are not limited to, unified communication services, communication conferencing services, instant messaging services, chat services, multi-media services, virtual reality services, web services, social networking services, productivity services, e-commerce services, dedicated avatar services, and gaming services, as well as any other suitable service.

FIG. 8 illustrates a computing system 801 that is representative of any computing systems or systems with which the various operational architectures, processes, scenarios, and sequences disclosed herein may be implemented. Examples of computing system 801 include, but are not limited to, server computers, web servers, application servers, rack servers, blade servers, virtual servers, desktop computers, work stations, laptop computers, tablet computers, smart phones, hybrid computers, gaming machines, virtual machines, smart televisions, and watches and other wearable devices, as well as any variation or combination thereof. In some implementations, a collection of multiple computing systems may be employed to implement all or portions of an application or service which may be hosted in one or more data centers, virtual data centers, or any other suitable computing facilities.

Computing system 801 may be implemented as a single apparatus, system, or device or may be implemented in a distributed manner as multiple apparatuses, systems, or devices. Computing system 801 includes, but is not limited to, processing system 802, storage system 803, software 805, communication interface system 807, and user interface system 809. Processing system 802 is operatively coupled with storage system 803, communication interface system 807, and user interface system 809.

Processing system 802 loads and executes software 805 from storage system 803. When executed by processing system 802 to implement enhanced avatar technology, software 805 directs processing system 802 to operate as described herein for the various processes, operational scenarios, and sequences discussed in the foregoing implementations. Computing system 801 may optionally include additional devices, features, or functionality not discussed for purposes of brevity.

Referring still to FIG. 8, processing system 802 may comprise a microprocessor and other circuitry that retrieves and executes software 805 from storage system 803. Processing system 802 may be implemented within a single processing device but may also be distributed across multiple processing devices or sub-systems that cooperate in executing program instructions. Examples of processing system 802 include general purpose central processing units, application specific processors, and logic devices, as well as any other type of processing device, combinations, or variations thereof.

Storage system 803 may comprise any computer readable storage media readable by processing system 802 and capable of storing software 805. Storage system 803 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 803 may also include computer readable communication media over which software 805 may be communicated internally or externally. Storage system 803 may be implemented as a single storage device but may also be implemented across multiple storage devices or sub-systems co-located or distributed relative to each other. Storage system 803 may comprise additional elements, such as a controller, capable of communicating with processing system 802 or possibly other systems.

Software 805 includes translation process 806, which is representative of translation processes 300 and 725. Software 805 in general, and translation process 806 in particular, may be implemented in program instructions that among other functions may, when executed by processing system 802, direct processing system 802 to operate as described with respect to the various operational scenarios, sequences, and processes illustrated herein.

The program instructions may include various components or modules that cooperate or otherwise interact to carry out the various processes and operational scenarios described herein. The various components or modules may be embodied in compiled or interpreted instructions or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 805 may include additional processes, programs, or components, such as operating system software or other application software. Software 805 may also comprise firmware or some other form of machine-readable processing instructions executable by processing system 802.

In general, software 805 may, when loaded into processing system 802 and executed, transform a suitable apparatus, system, or device (of which computing system 801 is representative) overall from a general-purpose computing system into a special-purpose computing system customized to facilitate enhanced avatar technology. Indeed, encoding software 805 on storage system 803 may transform the physical structure of storage system 803. The specific transformation of the physical structure may depend on various factors in different implementations of this description. Examples of such factors may include, but are not limited to, the technology used to implement the storage media of storage system 803 and whether the computer-storage media are characterized as primary or secondary storage, as well as other factors.

For example, if the computer readable storage media are implemented as semiconductor-based memory, software 805 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Referring again to FIGS. 1-3 as an example, through the operation of a computing system or systems of which computing system 801 is representative, transformations may be performed with respect to user actions 115. In a first state, user actions 115 are received by avatar engine 101. Avatar engine 101 processes user actions 115 using translation process 300 to produce user driven actions 125 and modified action 126, thereby transforming the actions.

It may be understood that computing system 801 is generally intended to represent a computing system or systems on which software 805 may be deployed and executed in order to implement translation process 806. However, computing system 801 may also be suitable as any computing system on which software 805 may be staged and from where one or both may be distributed, transported, downloaded, or otherwise provided to yet another computing system for deployment and execution, or yet additional distribution.

Communication interface system 807 may include communication connections and devices that allow for communication with other computing systems over a communication network. Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 809 is optional and may include a keyboard, a mouse, a voice input device, an image or video capture device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 809. In some cases, the input and output devices may be combined in a single device, such as a display capable of displaying images and receiving touch gestures. The aforementioned user input and output devices are well known in the art and need not be discussed at length here.

User interface system 809 may also include associated user interface software executable by processing system 802 in support of the various user input and output devices discussed above. Separately or in conjunction with each other and other hardware and software elements, the user interface software and user interface devices may support a graphical user interface, a natural user interface, or any other type of user interface. Examples include user interface 705 and user interface 715. In addition, user input made with respect to the user interfaces can be input via user interface system 809.

Communication between computing system 801 and any other computing system may occur over a communication network or networks (such as communication network 710) and in accordance with various communication protocols, combinations of protocols, or variations thereof. Examples of such communication networks include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some communication protocols that may be used include, but are not limited to, the Internet protocol (IP, IPv4, IPv6, etc.), the transfer control protocol (TCP), and the user datagram protocol (UDP), as well as any other suitable communication protocol, variation, or combination thereof.

In any of the aforementioned examples in which information is exchanged, the exchange of information may occur in accordance with any of a variety of protocols, including XMPP (extensible messaging and presence protocol), FTP (file transfer protocol), HTTP (hypertext transfer protocol), HTTPS (HTTP secure), SOAP (simply object access protocol), REST (representational state transfer), WebSocket, DOM (Document Object Model), HTML (hypertext markup language), CSS (cascading style sheets), HTML5, XML (extensible markup language), JavaScript, JSON (JavaScript Object Notation), and AJAX (Asynchronous JavaScript and XML), as well as any other suitable protocol, variation, or combination thereof.

While FIGS. 1-8 generally depict relatively few users and relatively few instances of service platforms, application platforms, applications, and services, it may be appreciated that the concepts disclosed herein may be applied at scale. For example, the translation processes disclosed herein could be deployed in support of any number of avatar sessions, applications, services, and instances thereof.

Various improvements to avatar technology may be appreciated from the foregoing implementations. The ability to translate user actions to avatar actions using session-specific profiles improves the empathy and connectedness associated with an avatar session. Such technical effects improve the functioning of avatar applications and services and increases the usability of such applications and services.

Certain inventive aspects may be appreciated from the foregoing disclosure, of which the following are various examples.

### Example 1

One or more computer readable storage media having program instructions stored thereon for enhancing avatar technology that, when executed by a processing system, direct the processing system to at least: identify a session profile for an avatar session to apply when evaluating user actions generated by a user for potential expression in avatar actions associated with an avatar; evaluate the user actions to determine if the user actions agree with the session profile for the avatar session; and for at least a user action of the user actions that does not agree with the session profile for the avatar session, express a modified version of the user action through the avatar actions that does agree with the session profile for the avatar session.

### Example 2

The computer readable storage media of Example 1 wherein to identify the session profile, the program instructions direct the processing system to select the session profile from a plurality of possible profiles based at least in part on a context of the avatar session.

### Example 3

The computer readable storage media of Examples 1-2 wherein the plurality of possible profiles each comprise a different range of allowed actions and wherein to evaluate the user actions to determine if the user actions agree with the session profile, the program instructions direct the processing system to determine whether or not the user actions fall within the range of allowed actions.

### Example 4

The computer readable storage media of Examples 1-3 wherein the program instructions further direct the processing system to identify the context of the avatar session based on a plurality of characteristics of the avatar session.

### Example 5

The computer readable storage media of Examples 1-4 wherein to express the modified version of the user action, the program instructions direct the processing system to express a synthetic action in place of the action.

### Example 6

The computer readable storage media of Examples 1-5 wherein the modified version of the action comprises a blend of only a portion of the user action and a synthetic action.

### Example 7

The computer readable storage media of Examples 1-6 wherein the user action comprises an extended gaze and wherein the synthetic action comprises a redirected gaze.

### Example 8

The computer readable storage media of Examples 1-7 wherein the user action comprises a gesture and wherein the synthetic action comprises a redirected gesture.

### Example 9

A method for enhancing avatar sessions comprising: identifying a session profile for an avatar session to apply when evaluating user actions generated by a user for potential expression in avatar actions associated with an avatar; evaluating the user actions to determine if the user actions agree with the session profile for the avatar session; and for at least a user action of the user actions that does not agree with the session profile for the avatar session, expressing a modified version of the user action through the avatar actions that does agree with the session profile for the avatar session.

### Example 10

The method of Example 9 wherein identifying the session profile comprises selecting the session profile from a plurality of possible profiles based at least in part on a context of the avatar session.

### Example 11

The method of Examples 9-10 wherein the plurality of possible profiles each comprise a different range of allowed actions and wherein evaluating the user actions comprises determining whether or not the user actions fall within the range of allowed actions.

### Example 12

The method of Examples 9-11 further comprising identifying the context of the avatar session based on a plurality of characteristics of the avatar session.

### Example 13

The method of Examples 9-12 wherein expressing the modified version of the user action comprises expressing a synthetic action in place of the action.

### Example 14

The method of Examples 9-13 wherein the modified version of the action comprises a blend of only a portion of the user action and a synthetic action.

### Example 15

The method of Examples 9-14 wherein the user action comprises an extended gaze and wherein the synthetic action comprises a redirected gaze.

### Example 16

The method of Examples 9-15 wherein the user action comprises a gesture and wherein the synthetic action comprises a redirected gesture.

### Example 17

An apparatus comprising: one or more computer readable storage media; and program instructions stored on the one or more computer readable storage media for enhancing avatar technology that, when executed by a processing system, direct the processing system to at least: identify an empathy profile for an avatar session to apply to interaction sequences that occur during the avatar session; capture user actions generated by a user during an interaction sequence between an avatar associated with the user and at least a participant in the avatar session; generate avatar actions for the interaction sequence comprising a blend of synthetic avatar actions and user-driven avatar actions corresponding to a subset of the user actions such that the avatar actions during the interaction sequence are in agreement with the empathy profile for the avatar session; and drive the avatar to surface the avatar actions, including the blend of the synthetic avatar actions and the user-drive actions.

### Example 18

The apparatus of Example 17 wherein the program instructions further direct the processing system to select the empathy profile from a plurality of empathy profiles based on a plurality of characteristics of the avatar session.

### Example 19

The apparatus of Examples 17-18 wherein each of the plurality of empathy profiles different level of dedication to reproducing the user actions as avatar actions relative to each other of the plurality of empathy profiles.

### Example 20

The apparatus of Examples 17-19 further comprising the processing system configured to execute the program instructions, wherein the user actions comprise an extended gaze and a gesture, wherein the synthetic actions comprise a redirected gaze and a redirected gesture.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. One or more computer readable storage media having program instructions stored thereon for enhancing avatar technology that, when executed by a processing system, direct the processing system to at least:
identify a session profile for an avatar session to apply when evaluating user actions generated by a user for potential expression in avatar actions associated with an avatar;
evaluate the user actions to determine if the user actions agree with the session profile for the avatar session; and
for at least a user action of the user actions that does not agree with the session profile for the avatar session, express a modified version of the user action through the avatar actions that does agree with the session profile for the avatar session.

2. The computer readable storage media of claim 1 wherein to identify the session profile, the program instructions direct the processing system to select the session profile from a plurality of possible profiles based at least in part on a context of the avatar session.

3. The computer readable storage media of claim 2 wherein the plurality of possible profiles each comprise a different range of allowed actions and wherein to evaluate the user actions to determine if the user actions agree with the session profile, the program instructions direct the processing system to determine whether or not the user actions fall within the range of allowed actions.

4. The computer readable storage media of claim 2 wherein the program instructions further direct the processing system to identify the context of the avatar session based on a plurality of characteristics of the avatar session.

5. The computer readable storage media of claim 1 wherein to express the modified version of the user action, the program instructions direct the processing system to express a synthetic action in place of the user action.

6. The computer readable storage media of claim 1 wherein the modified version of the user action comprises a blend of only a portion of the user action and a synthetic action.

7. The computer readable storage media of claim 6 wherein the user action comprises an extended gaze and wherein the synthetic action comprises a redirected gaze.

8. The computer readable storage media of claim 6 wherein the user action comprises a gesture and wherein the synthetic action comprises a redirected gesture.

9. A method for enhancing avatar sessions comprising:
identifying a session profile for an avatar session to apply when evaluating user actions generated by a user for potential expression in avatar actions associated with an avatar;
evaluating the user actions to determine if the user actions agree with the session profile for the avatar session; and
for at least a user action of the user actions that does not agree with the session profile for the avatar session, expressing a modified version of the user action through the avatar actions that does agree with the session profile for the avatar session.

10. The method of claim 9 wherein identifying the session profile comprises selecting the session profile from a plurality of possible profiles based at least in part on a context of the avatar session.

11. The method of claim 10 wherein the plurality of possible profiles each comprise a different range of allowed actions and wherein evaluating the user actions comprises determining whether or not the user actions fall within the range of allowed actions.

12. The method of claim 10 further comprising identifying the context of the avatar session based on a plurality of characteristics of the avatar session.

13. The method of claim 9 wherein expressing the modified version of the user action comprises expressing a synthetic action in place of the user action.

14. The method of claim 9 wherein the modified version of the user action comprises a blend of only a portion of the user action and a synthetic action.

15. The method of claim 14 wherein the user action comprises an extended gaze and wherein the synthetic action comprises a redirected gaze.

16. The method of claim 14 wherein the user action comprises a gesture and wherein the synthetic action comprises a redirected gesture.

17. An apparatus comprising:
one or more computer readable storage media;
program instructions stored on the one or more computer readable storage media for enhancing avatar technology that, when executed by a processing system, direct the processing system to at least:
identify a session profile for an avatar session to apply to interaction sequences that occur during the avatar session;
capture user actions generated by a user during an interaction sequence between an avatar associated with the user and at least a participant in the avatar session;
generate avatar actions for the interaction sequence comprising a blend of synthetic avatar actions and user-driven avatar actions corresponding to a subset of the user actions such that the avatar actions during the interaction sequence are in agreement with the session profile for the avatar session; and
drive the avatar to surface the avatar actions, including the blend of the synthetic avatar actions and the user-driven avatar actions.

18. The apparatus of claim 17 wherein the program instructions further direct the processing system to select the session profile from a plurality of session profiles based on a plurality of characteristics of the avatar session.

19. The apparatus of claim 18 wherein each of the plurality of session profiles differ relative to each other of the plurality of session profiles with respect to which of the user actions are in agreement and which of the user actions are not in agreement.

20. The apparatus of claim 18 further comprising the processing system configured to execute the program instructions, wherein the user actions comprise an extended gaze and a gesture, wherein the synthetic actions comprise a redirected gaze and a redirected gesture.
